(19) United States
(12) Patent Application Publication
(10) Pub. No.: US 2009/0166285 A1
(43) Pub. Date: Jul. 2, 2009

(54) Disengagement-preventing device for threading coupling of drinking water filter element

(76) Inventor: Chuan Chin Shen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,797

(22) Filed: Jan. 2, 2008

(51) Int. Cl. B01D 35/14

(52) U.S. Cl. 210/455

(57) ABSTRACT

A drinking water filter element includes a filter housing including a protruded portion on an end thereof. The protruded portion includes outer threading having a threading path in which a gap is defined. A cap is removably mounted to the end of the filter housing and includes a peripheral wall having inner threading on an inner peripheral face thereof. The cap further includes an opening extending through the peripheral wall and aligned the gap. A switch extends through the opening of the cap and movable between an engaging position engaged in the gap of the filter housing such that the cap can not be disengaged from the filter housing and a disengaging position disengaged from the gap of the filter housing such that the cap can be unscrewed from the filter housing.

### BACKGROUND OF THE INVENTION

The present invention relates to a disengagement-preventing device for threading coupling of a filter element and, more particularly, to a device preventing undesired disengagement of threading coupling of a drinking water filter element.

Water is usually boiled to kill bacteria. Nowadays, various filter apparatuses and purifiers have been developed for various water-filtering purposes. A typical water filter apparatus or purifier includes a filter element, and there are currently a wide of variety of commercially available filter elements for various purpose such as removing impurities, odors, etc. A typical filter element includes a filter housing containing a cartridge for removing impurities and odor and a cap removably mounted to the filter housing by threading coupling. The cap includes a water inlet and a water outlet that are in communication with an interior of the filter housing. However, the threading coupling is apt to become loosened due to excessive water pressure or rapid pressure change. As a result, the cap is liable to disengage from the filter housing, leading to water leakage.

### BRIEF SUMMARY OF THE INVENTION

A drinking water filter element according to the preferred teachings of the present invention includes a filter housing including a protruded portion on an end thereof. The protruded portion includes outer threading having a threading path. A gap is defined in the threading path. A cap is removably mounted to the end of the filter housing and includes a peripheral wall having inner threading on an inner peripheral face thereof. The cap further includes an opening extending through the peripheral wall and aligned the gap of the filter housing. A switch extends through the opening of the cap and movable between an engaging position engaged in the gap of the filter housing and a disengaging position disengaged from the gap of the filter housing. The cap is fixed relative to the filter housing when the switch is in the engaging position, preventing the cap from disengaging from the filter housing. A tight sealing effect without the risk of undesired disengagement is, thus, provided between the cap and the filter housing. The cap is unscrewable from the filter housing when the switch is in the disengaging position.

The present invention will become clearer in light of the following detailed description of an illustrative embodiment of this invention described in connection with the drawings.

### DESCRIPTION OF THE DRAWINGS

FIG. 1 shows a perspective of a drinking water filter element according to the preferred teachings of the present invention.

FIG. 2 shows an exploded perspective view of the drinking water filter element of FIG. 1.

FIG. 3 shows a partial, cross-sectional view of the drinking water filter element of FIG. 1 according to section line A-A of FIG. 1, with a switch of the drinking water filter element in an engaging position.

FIG. 4 shows a partial, cross-sectional view of the drinking water filter element of FIG. 1 according to section line B-B of FIG. 1, with the switch in a disengaging position.

FIG. 5 shows a partial, cross-sectional view of the drinking water filter element of FIG. 1 according to section line B-B of FIG. 1.

FIG. 6 shows an enlarged view of a circled portion in FIG. 5.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

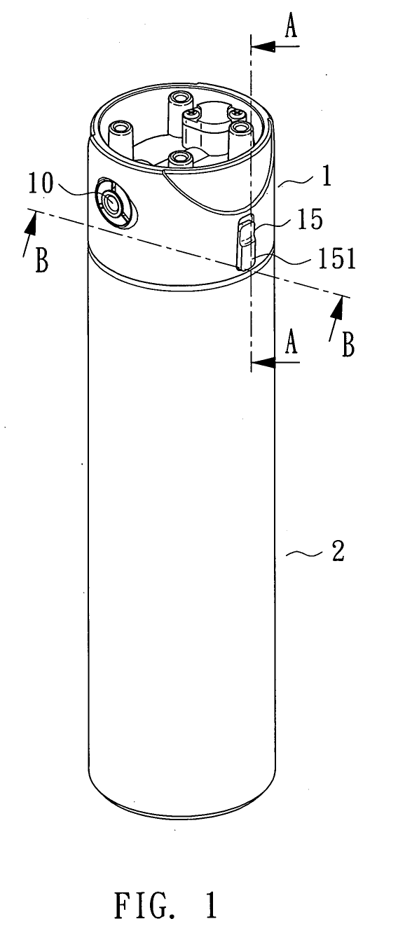

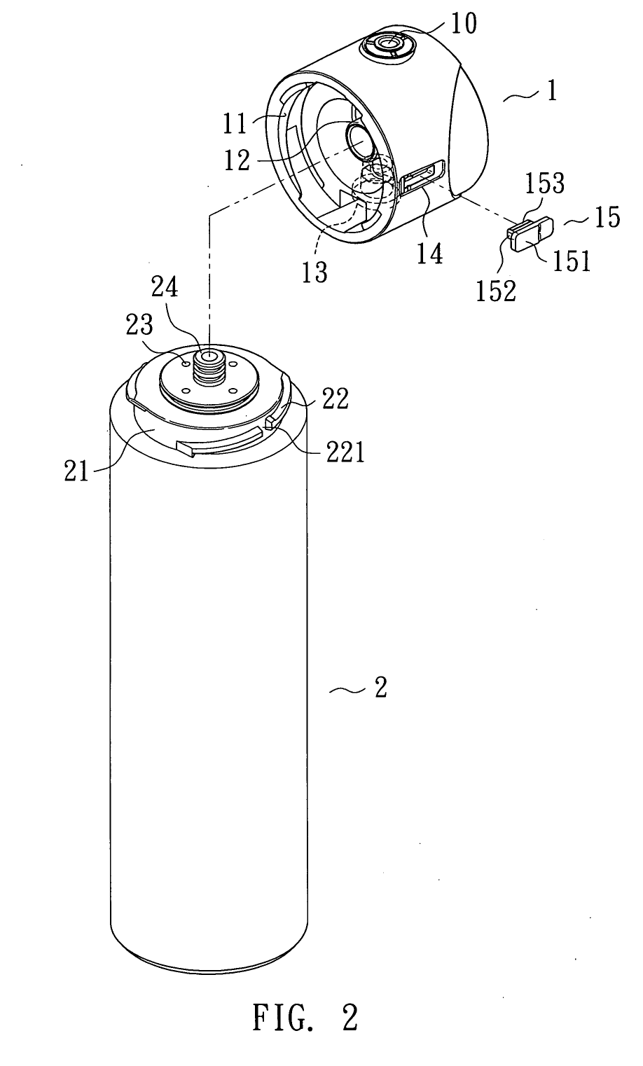

A drinking water filter element according to the preferred teachings of the present invention is shown in the drawings and generally includes a filter housing 2 and a cap 1 removably coupled with the filter housing 2. With reference to FIGS. 1 and 2, the cap 1 is in the form of a shallow container having a downwardly facing opening. The cap 1 includes a water inlet 10 in a side thereof. A water tube 12 is provided in the cap 1 and in communication with the water inlet 10. The cap 1 further includes a water outlet 13 in communication with an interior of the cap 1. The cap 1 further includes a peripheral wall having inner threading 11 on an inner peripheral face thereof. The cap 1 further includes an opening 14 extending through the peripheral wall to the outside. The opening 14 is located in a threading path of the inner threading 11. The opening 14 can extend across at least one crest and/or at least one valley of the inner threading 11.

The filter housing 2 is substantially cylindrical and includes a cartridge (not shown) mounted therein for filtering water. The filter housing 2 includes an end to which the cap 1 is removably coupled. The end of the filter housing 2 includes a protruded portion 21 having outer threading 22 on an outer periphery thereof for threading connection with the inner threading 11 of the cap 1. The protruded portion 21 includes an inlet tube 24 in communication with the water tube 12 of the cap 1. The protruded portion 21 further includes at least one water outlet hole 23 (four in this example) in communication with the interior of the cap 1. Filtered water is flowable through the water outlet holes 23 into the interior of the cap 1 and then output through the water outlet 13. A gap 221 is defined in a threading path of the outer threading 22 and aligned with the opening 14. The gap 221 can extend across at least one crest and/or at least one valley of the outer threading 22. The gap 221 has a width slightly larger than that of the opening 14 of the cap 1.

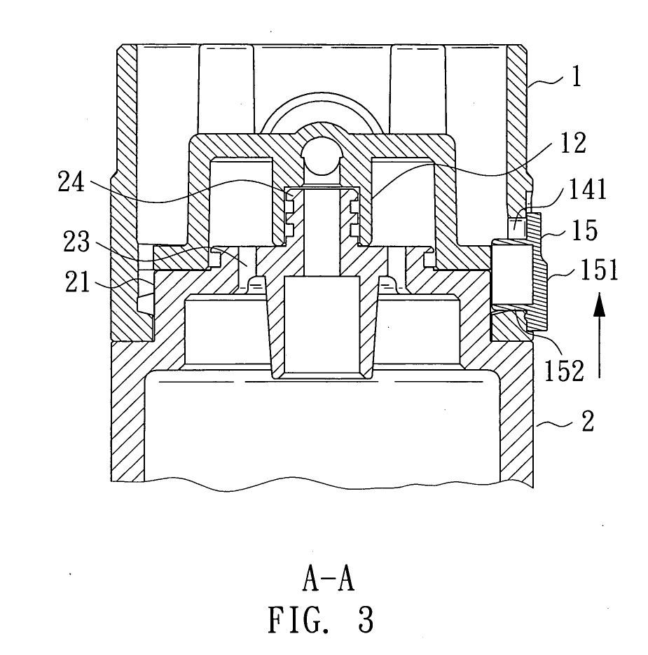

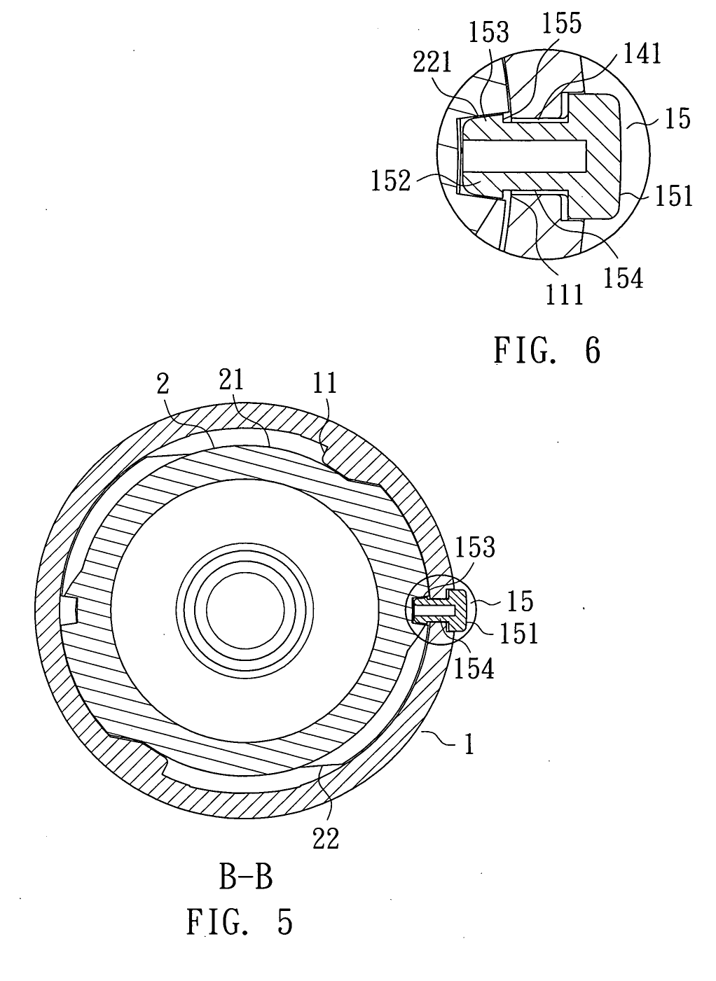

With reference to FIGS. 3-6, a switch 15 extends through the opening 14 of the cap 1. The switch 15 is movable between an engaging position engaged in the gap 221 of the filter housing 2 and a disengaging position disengaged from the gap 221 of the filter housing 2. The cap 1 is fixed relative to the filter housing 2 when the switch is in the engaging position, preventing the cap 1 from disengaging from the filter housing 2. On the other hand, the cap 1 can be unscrewed from the filter housing 2 when the switch 15 is in the disengaging position.

According to the most preferred form shown, the opening 14 of the cap 1 includes a neck portion 41 having an inner diameter smaller than that of the opening 14. The switch 15 includes a body 151 located outside the cap 1 for manual operation. The switch 15 further includes a pin 152 extending from the body 151 through the opening 14 of the cap 1 into the gap 221. The pin 152 includes a distal end 153 and a reduced section 154 adjacent to the distal end 153. The reduced section 154 has a width smaller than that of the distal end 153. A shoulder 155 is, thus, formed between the distal end 153 and the reduced section 154, best shown in FIG. 6.

The width of the distal end 153 of the pin 152 is slightly larger than that of the neck portion 141 of the opening 14. The distal end 153 of the pin 152 is made of resilient material and can be forcibly inserted through the opening 14 of the cap 1 into the gap 221 of the filter housing 2. The neck portion 141 of the opening 14 includes an abutting edge 141. When the switch 15 is pulled outward away from the cap 1, the shoulder 155 is stopped by the abutting edge 141 to prevent the switch 15 from disengaging from the cap 1. The distal end 153 of the pin 152 is movable between the engaging position and disengaging position by moving the switch 15 upward or downward. The neck portion 141 of the opening 14 of the cap 1 slideably receives the reduced section 154 of the pin 152.

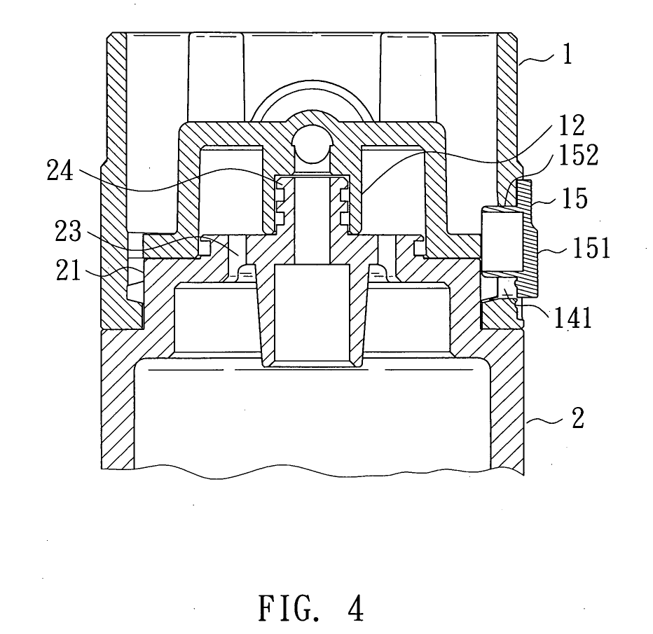

When the switch 15 is in the engaging position (FIG. 3), the distal end 153 of the pin 152 is in the gap 221 of the filter housing 2 such that the cap 2 is fixed relative to the filter housing 2. A tight sealing effect without the risk of undesired disengagement is, thus, provided between the cap 1 and the filter housing 2. When the switch 15 is moved to the disengaging position (FIG. 4), the distal end 153 of the pin 152 is disengaged from the gap 221 of the filter housing 2 such that the cap 1 can be unscrewed from the filter housing 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A drinking water filter element comprising:
a filter housing including a protruded portion on an end thereof, with the protruded portion including outer threading having a threading path, with a gap being defined in the threading path;
a cap removably mounted to the end of the filter housing, with the cap including a peripheral wall having inner threading on an inner peripheral face thereof, with the cap further including an opening extending through the peripheral wall and aligned the gap of the filter housing; and
a switch extending through the opening of the cap, with the switch being movable between an engaging position engaged in the gap of the filter housing and a disengaging position disengaged from the gap of the filter housing,
with the cap being fixed relative to the filter housing when the switch is in the engaging position, preventing the cap from disengaging from the filter housing, and
with the cap being unscrewable from the filter housing when the switch is in the disengaging position.

2. The drinking water filter element as claimed in claim 1, with the opening extending across at least one crest and/or at least one valley of the inner threading.

3. The drinking water filter element as claimed in claim 1, with the gap of the filter housing having a width slightly larger than that of the opening of the cap, with the opening of the cap including a neck portion having an inner diameter smaller than that of the opening, with the switch including a body located outside the cap for manual operation, with the switch further including a pin extending from the body through the opening into the gap, with the pin including a distal end and a reduced section having a width smaller than that of the distal end, with the width of the distal end of the pin being slightly larger than that of the neck portion of the opening, with the distal end of the pin being made of resilient material and forcibly insertable through the opening of the cap into the gap of the filter housing, with the distal end of the pin being movable between the engaging position and disengaging position, and with the neck portion of the opening of the cap slideably receiving the reduced section of the pin.

4. The drinking water filter element as claimed in claim 1, with the pin including a shoulder formed between the distal end and the reduced section, with the neck portion of the opening including an abutting edge, and with the shoulder being stopped by the abutting edge when the switch is moved away from the cap, preventing the switch from disengaging from the cap.
